(19) United States
(12) Patent Application Publication
(10) Pub. No.: US 2003/0179187 A1
(43) Pub. Date: Sep. 25, 2003

(54) Convertible display device

(75) Inventors: Anthony Edward Martinez, Spicewood, TX (US); Valerie Jill Fox, Toronto (CA)

Correspondence Address: Robert V. Wilder, Attorney at Law, 4235 Kingsburg Drive, Round Rock, TX, 78681, US

(73) Assignee: International Business Machines Corporation, Armonk, NY

(21) Appl. No.: 10/105,132

(22) Filed: Mar. 21, 2002

(51) Int. Cl. G09G 5/00

(52) U.S. Cl. 345/173

(57) ABSTRACT

An improved methodology and implementing system are provided in which a display device is selectively converted by a user to change its processing configuration from a first mode which suitable for use in a first computer environment, to a second mode which is suitable for use in a second computer environment. In an exemplary embodiment, a display device is configured to also act as a touch-sensitive input unit to provide user input in a hand-held computing system. The display device is further enabled to be converted for use as the display in a laptop computer system with a keyboard and/or mouse input. Each configuration has a separate bus and includes a separate CPU. A common display device and palm unit non-volatile memory are accessible from either configuration. A user is enabled to input a selected mode of operation and configuration for the display device through a selection switch on the display device. In an alternate arrangement, the selected mode of operation is automatically determined by internal programming designed to detect the type of device that is connected to the display.

### FIELD OF THE INVENTION

The present invention relates generally to information processing systems and more particularly to a method and apparatus for providing a convertible, multi-purpose display device.

### BACKGROUND OF THE INVENTION

As computer systems have evolved, new uses and applications for computer technology have proliferated. Currently, computer systems come in many shapes and sizes including mainframe computers, servers, personal computer stations, laptop computers and personal handheld computing devices such as personal digital assistants or PDAs. Each of these computing systems is specifically designed to apply to one or only a few applications and each computing system typically contains a set of sub-system components which are designed to function for only one application. For example, it is common for users to own a desktop personal computer (PC), a laptop PC and also a hand-held computing device. Each of these computing systems generally includes a separate display device as well as a separate system bus and separate processor and memory sub-systems.

The coordination of information and data among all of the various computing systems for a single user has become a challenging and time consuming task. Further, the task of travelling with so many various computing systems, and their respective components, has become relatively burdensome for the computer user.

Thus, there is a need for an improved method and system for selectively providing computer systems and sub-systems which are better designed for hardware commonality and interchangeability such that greater functionality can be provided using fewer component parts.

### SUMMARY OF THE INVENTION

An improved methodology and implementing system are provided in which a display device is selectively converted by a user to change its processing configuration from a first mode which suitable for use in a first computer environment, to a second mode which is suitable for use in a second computer environment. In an exemplary embodiment, a display device is configured to also act as a touch-sensitive input unit to provide user input and in a hand-held computing system. The display device is further enabled to be converted for use as the display in a laptop computer system with a keyboard and/or mouse input. Each configuration has a separate bus and includes a separate CPU. A common display device and palm unit non-volatile memory are accessible from either configuration. A user is enabled to input a selected mode of operation and configuration for the display device through a selection switch on the display device. In an alternate arrangement, the selected mode of operation is automatically determined by internal programming designed to detect the type of device that is connected to the display.

### BRIEF DESCRIPTION OF THE DRAWINGS

A better understanding of the present invention can be obtained when the following detailed description of a preferred embodiment is considered in conjunction with the following drawings, in which:

FIG. 1 is schematic drawing illustrating an exemplary embodiment of a display device in accordance with the present invention;

FIG. 2 is an illustration of different display device combinations which may be implemented using the present invention;

FIG. 3 is a schematic block diagram illustrating major components within a display device and a coupled base unit;

FIG. 4 a schematic block diagram illustrating major components within a display device and a coupled keyboard unit;

FIG. 5 is a schematic block diagram illustrating first and second bus arrangements within a display device constructed in accordance with the present invention; and

FIG. 6 is a flowchart illustrating an sequence of operation which may be implemented in accordance with the present invention.

### DETAILED DESCRIPTION

The various methods discussed herein may be implemented, for example, within a typical personal computer (PC) system which may include a laptop computer and a palm-held wireless digital device. Both the laptop and the wireless device in the illustrated example use the same display device and the internal configuration of the wireless device is different depending upon which external device is being coupled to the display device. The present invention may be implemented in either a hardware design or in software or a combination of both hardware and software.

In general, the present invention is illustrated in sufficient detail to enable those skilled in the art to practice the invention. Electronic components and circuits which are generally known to those skilled in the art, are not specified to any greater extent than that considered necessary as illustrated, for the understanding and appreciation of the underlying concepts of the present invention and in order not to obfuscate or distract from the teachings of the present invention.

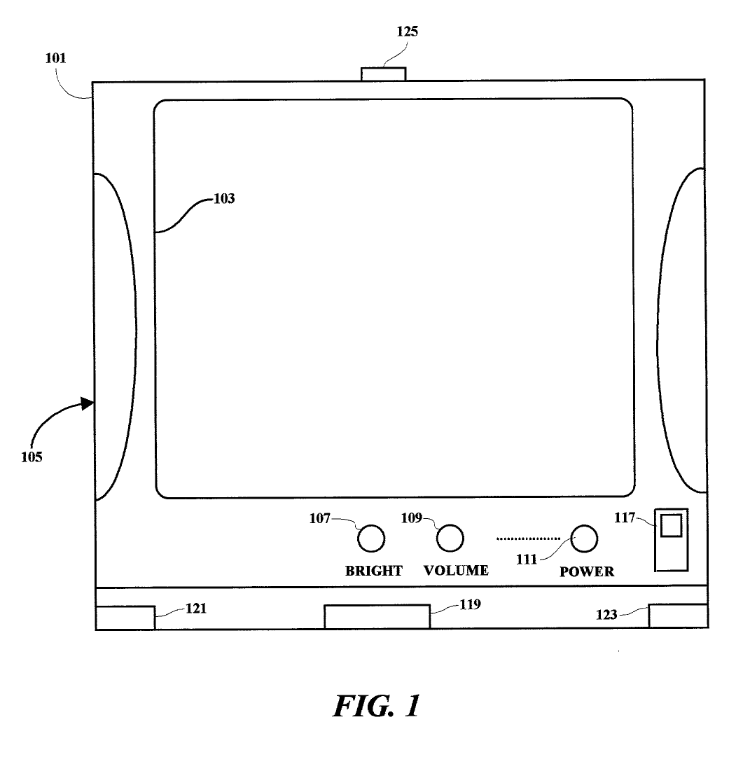

In all of the drawings, like numerals refer to like parts. In an exemplary embodiment illustrated in FIG. 1, a display device 101 includes a display screen area 103. The display screen 103 in the present example is a touch-sensitive screen such that various menus may be displayed and items may be selected from the menus by touching or applying pressure to the selected items on the display screen with a finger or pen or similar item. The display device 101 as shown includes cut-outs 105 on each side of the display screen to aid a user in grasping the display device. Several buttons and knobs 107, 109 and 111 are shown along the lower portion of the display device 101 to enable user control of various display functions such as brightness, audio volume and power, respectively. Other controls may also be included. A mode switch 117 is implemented in the present example as a thumb switch which is used to enable a user to select one of two possible modes of operation for the display device 101. The mode of operation of the display device 101 will depend upon the hardware which is coupled to the display device as is hereinafter explained in detail. The display device 101 also includes an electrical connector means 119 which is used to couple the display device to either a base unit in a palm-held application or a keyboard unit in a laptop application. Other coupling mechanisms 121 and 123 are illustrated for mechanical support of the display device to the unit to which it may be coupled. The display device 101 may also include a receiver/transmitter means 125 for communicating with external remote system devices.

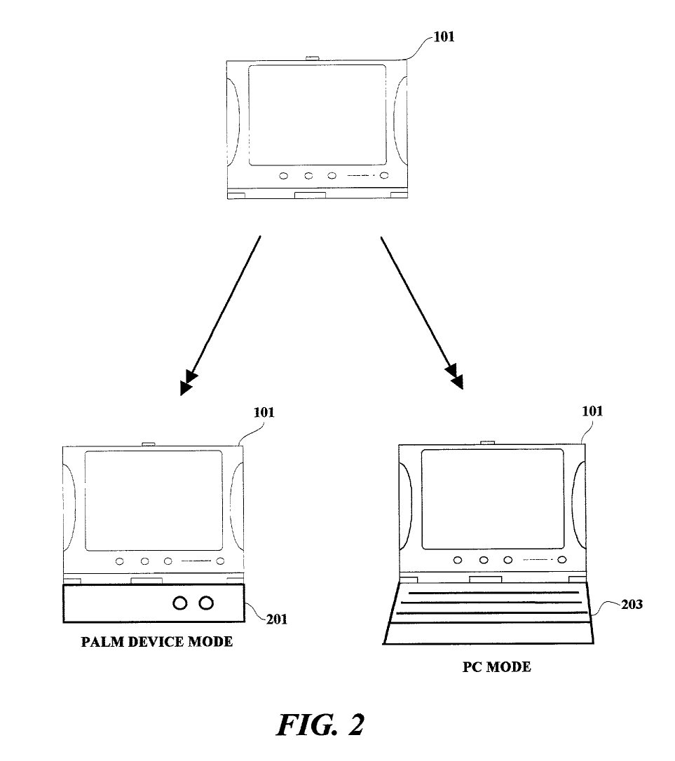

As shown in FIG. 2, the display device 101 may be coupled to a palm base unit 201, or, in a second mode of operation, to a keyboard base unit 203. The mode switch 117 will be set in accordance with the selected mode of operation and may be changed by the user as needed. Alternatively, the device which is coupled to the display device 101 may be determined automatically by software within the display device by detecting the presence or absence of predetermined pins or receipt of predetermined signals or signal levels from the attached unit. In the palm-held mode, the display device 101 is coupled to the base unit and functions in any of many available palm-held applications in which user input is enabled through the touch-sensitive screen 103. The base unit, for example, may include, inter alla, a battery for supplying power to the display device 101 through connector 119 when operating in the palm-held mode. In the PC or laptop mode, the display device 101 is coupled to a keyboard base unit 203 and functions as a laptop computer. The keyboard base unit 203 is designed to receive the display device and electrically connect to the display device 101 through the connection means 119. The keyboard unit 203 may also be a wireless unit which is enabled to communicate with the display device 101 by wireless communication techniques without the need for the electrical connector 119. Also, the display device 101 may be coupled to a desktop stand and operated in combination with a wireless keyboard or mouse or other input means.

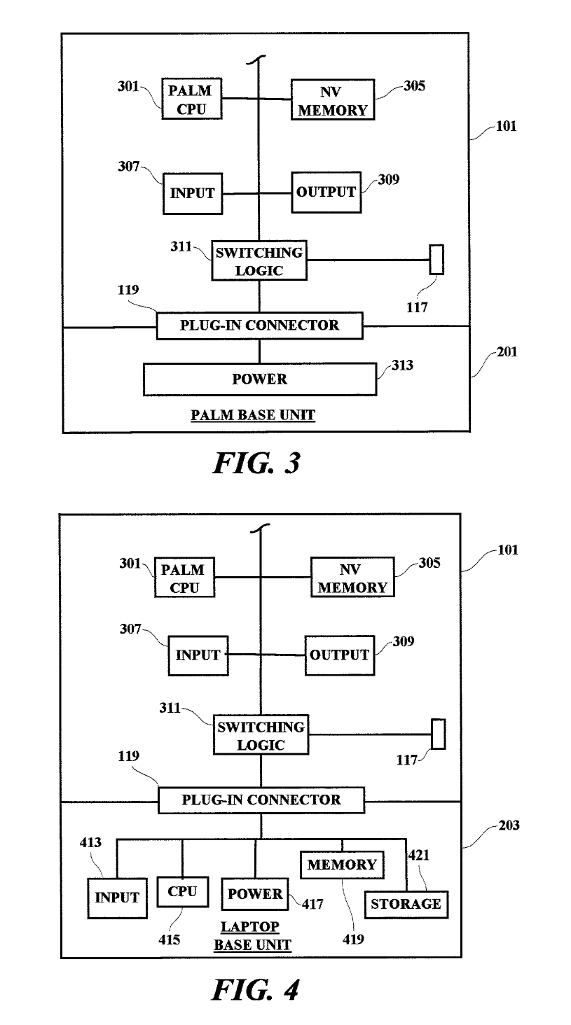

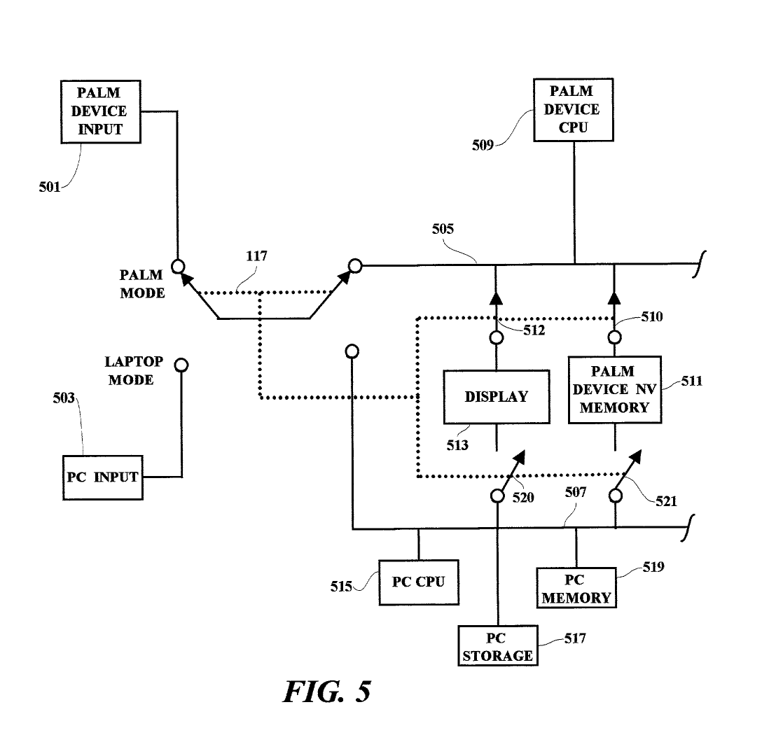

As shown in FIG. 3, when the display device 101 is connected to a palm base unit 201, the display device operates in a palm-held mode. In this configuration, the selection switch 117 is set to a “Palm Mode” setting, and switching logic 311 within the display device 101 detects the selected setting and implements the necessary configuration as shown in more detail in FIG. 5. The palm base unit 201 in the example, provides power 313 to the display device 101. As shown in FIG. 3, the display device includes a palm CPU 301, a non-volatile memory 305 such as a flash memory, input circuitry 307 and output circuitry 309. As noted earlier, the input in the example is through the touch-sensitive screen 103 in the palm-held mode. The output is also displayed on the screen 103. The switching logic 311, or the connector 119, detects the selected mode and implements the appropriate bus arrangement within the display device 101.

As shown in FIG. 4, a keyboard base unit 203 as illustrated includes input means 413, a CPU 415, a power supply 417, memory means 419 and storage 421. When the display device 101 is coupled to the keyboard base unit 203, the internal components (301, 305, 307, 309, 119 and 117) of the display device remain the same, but the connections among those components are modified to accommodate a laptop environment.

As shown in FIG. 5, when switch 117 is set to the “PALM MODE”, the display device is connected to the palm base unit 201 and the input device 501, which in the example is the touch sensitive screen 103, is coupled to a first or palm bus arrangement 505. As illustrated, in the first bus arrangement 505, the palm device CPU 509 is coupled through switch 512 to the display output 513. When the mode switch 117 is set to the laptop mode, the keyboard input or PC input 503 is coupled to a second or PC bus arrangement 507 which couples the PC CPU 515, the PC storage unit 517 and the PC memory 519 through switch 520 to the display output 513. The PC storage unit may be a hard drive or CD drive or the like. In the example, the PC CPU 515, the PC storage unit 517, the PC memory 519 and the second bus 507 are all contained within the detachable keyboard base unit 203. At any given point in time, the display 513 is connected to either the first bus 505 in the palm mode or the second bus 507 in the PC mode through either switch 512 or switch 520, respectively. Similarly, the palm NV memory 511 is connected to either the first bus 505 in the palm mode through switch 510, or the second bus 507 in the PC mode through switch 521. The ganged switching between the first and second bus arrangements can be accomplished either mechanically, electronically or by using a software implementation.

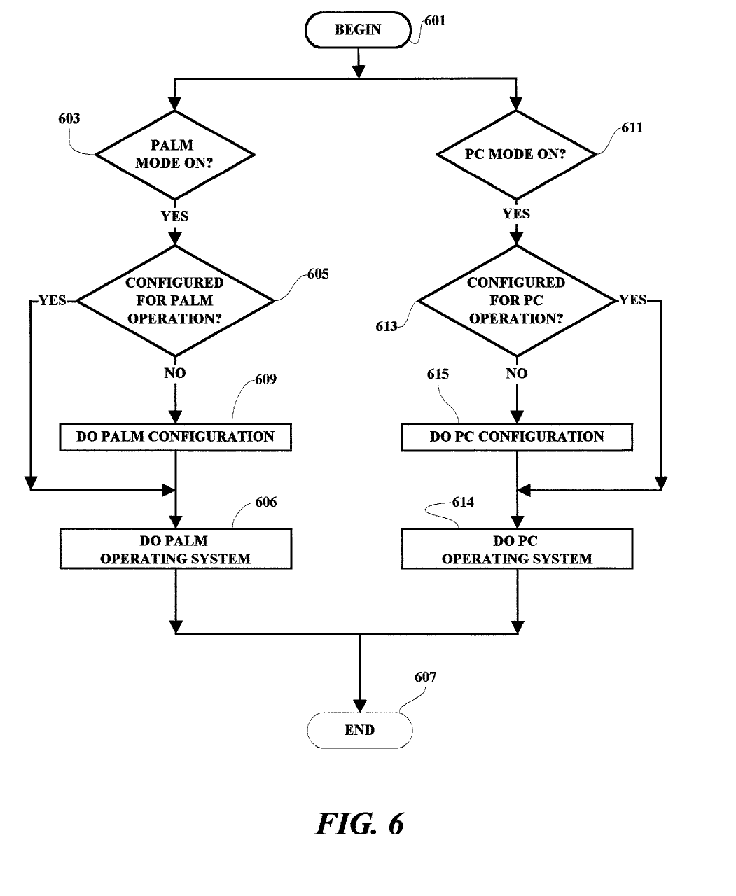

As shown in FIG. 6, when the display device 101 is turned on, the processing begins 601 by making a determination of the selected mode of operation. If the palm mode is selected 603, as determined for example either automatically or by the setting of switch 117, a check is made 605 to determine if the current bus arrangement is set for palm operation. If the palm mode is selected 603 and the first bus 505 is connected 605, then the palm operating system is initiated 606 and the bus configuration process ends 607. If, however, the first bus 505 is not the currently connected bus, then the necessary switching is accomplished 609 to connect the bus 505 to the input means 501 before the palm operating system is initiated 606 and the bus configuration process ends 607.

If the PC mode is selected 611, as determined for example either automatically or by the setting of switch 117, a check is made 613 to determine if the current bus arrangement is set for PC or keyboard operation. If the PC mode is selected 611 and the second bus 507 is connected 613, then the PC operating system is initiated 614 and the bus configuration process ends 607. If, however, the second bus 507 is not the currently connected bus, then the necessary switching is accomplished 615 to connect the bus 507 to the input means 503 before the PC operating system is initiated 614 and the bus configuration process ends 607.

The method and apparatus of the present invention has been described in connection with a preferred embodiment as disclosed herein. The disclosed methodology may be implemented in hardware, software or a combination of both hardware and software. Further, a wide range of sequences, menus and screen designs may be implemented to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A display device capable of operating in first and second modes of operation, said display device comprising:
a display screen;
a first bus arrangement;
means for connection to a second bus arrangement; and
switching means, said switching means being selectively operable for connecting said display screen to said first bus arrangement for operation of said display device in said first mode of operation, said switching means being further selectively operable for connecting said display screen to said second bus arrangement for operation of said display device in said second mode of operation.

2. The display device as set forth in claim 1 and further including first and second input means, said switching means being selectively operable to connect said first input means to said first bus arrangement in said first mode of operation, said switching means being further selectively operable for connecting said second input means to said second bus arrangement in said second mode of operation.

3. The display device as set forth in claim 2 wherein said display screen is a touch sensitive display screen, said touch sensitive display screen being operable to act as said first input means.

4. The display device as set forth in claim 2 wherein said second input means comprises a keyboard device, said keyboard device being arranged to be selectively connected to said display device.

5. The display device as set forth in claim 3 wherein said second input means comprises a keyboard device, said keyboard device being arranged to be selectively connected to said display device.

6. The display device as set forth in claim 1 wherein said first bus arrangement includes a first CPU and a first memory means.

7. The display device as set forth in claim 6 wherein said second bus arrangement includes a second CPU, a second memory means and a storage means.

8. The display device as set forth in claim 6 wherein said first memory means comprises a flash memory device.

9. The display device as set forth in claim 1 and further including means for wirelessly transferring information to and from devices external to said display device.

10. A method for selectively operating a display device in first or second modes of operation, said method comprising:
providing first and second bus arrangements for use in said first and second modes of operation, respectively; and
enabling a selective switching between said first and second modes of operation of said display device.

11. The method as set forth in claim 10 and further including providing first and second input means for enabling input to said display device during said first and second modes of operation, respectively.

12. The method as set forth in claim 11 and further including providing a touch sensitive screen capability for a display screen of said display device and enabling said touch sensitive display screen of said display device to function as said first input means.

13. The method as set forth in claim 11 and further including coupling a keyboard device to said display device, and enabling said keyboard device to function as said second input means.

14. The method as set forth in claim 12 and further including coupling a keyboard device to said display device, and enabling said keyboard device to function as said second input means.

15. The method as set forth in claim 10 and further including operating a first CPU on said first bus arrangement in said first mode of operation and operating a second CPU on said second bus arrangement in said second mode of operation.

16. The method as set forth in claim 15 and further including accessing a first memory means on said first bus arrangement in said first mode of operation and accessing a second memory means on said second bus arrangement in said second mode of operation.

17. The method as set forth in claim 16 wherein said first memory means is a flash memory device.

18. A computer system capable of operating in first and second modes of operation, said computer system comprising:
a display device including a display screen, said display screen including means for enabling touch sensitive input to said computer system in said first mode of operation;
a first bus arrangement within said display device;
a keyboard means including a second bus arrangement, said keyboard means being arranged for providing input to said computer system in said second mode of operation;
connection means for selectively connecting said keyboard means to said display device; and
switching means, said switching means being selectively operable for connecting said display screen to said first bus arrangement for operation of said display device in said first mode of operation, said switching means being further selectively operable for connecting said display screen to said second bus arrangement for operation of said display device in said second mode of operation.

19. The computer system as set forth in claim 18 and further including a non-volatile memory means, said non-volatile memory means being selectively accessible from either said first or said second bus arrangements.

20. The computer system as set forth in claim 19 wherein said non-volatile memory means comprises a flash memory device.
